(19) United States
(12) Patent Application Publication
(10) Pub. No.: US 2025/0267748 A1
(43) Pub. Date: Aug. 21, 2025

(54) DYNAMIC CONFIGURATION FAILURE MESSAGING

(71) Applicant: QUALCOMM Incorporated, San Diego, CA (US)

(72) Inventor: Bapineedu Chowdary GUMMADI, Hyderabad (IN)

(21) Appl. No.: 18/582,245

(22) Filed: Feb. 20, 2024

(51) Int. Cl. H04W 76/20; H04L 1/00; H04W 28/04; H04W 48/08

(52) U.S. Cl. CPC H04W 76/20; H04L 1/0061; H04W 28/04; H04W 48/08

(57) ABSTRACT

Various aspects of the present disclosure generally relate to wireless communication. In some aspects, a user equipment (UE) may receive a reconfiguration message that includes a configuration error. The UE may transmit a reconfiguration error message that indicates the configuration error. Numerous other aspects are described.

### FIELD OF THE DISCLOSURE

Aspects of the present disclosure generally relate to wireless communication and specifically relate to techniques, apparatuses, and methods for dynamic configuration failure messaging.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include receiving a reconfiguration message that includes a configuration error. The method may include transmitting a reconfiguration error message that indicates the configuration error.

Some aspects described herein relate to a method of wireless communication performed by a network node. The method may include transmitting a reconfiguration message that includes a configuration error. The method may include receiving a reconfiguration error message that indicates the configuration error.

Some aspects described herein relate to an apparatus for wireless communication at a UE. The apparatus may include one or more memories and one or more processors coupled to the one or more memories. The one or more processors may be configured to receive a reconfiguration message that includes a configuration error. The one or more processors may be configured to transmit a reconfiguration error message that indicates the configuration error.

Some aspects described herein relate to an apparatus for wireless communication at a network node. The apparatus may include one or more memories and one or more processors coupled to the one or more memories. The one or more processors may be configured to transmit a reconfiguration message that includes a configuration error. The one or more processors may be configured to receive a reconfiguration error message that indicates the configuration error.

Some aspects described herein relate to a non-transitory computer-readable medium that stores a set of instructions for wireless communication by a UE. The set of instructions, when executed by one or more processors of the UE, may cause the UE to receive a reconfiguration message that includes a configuration error. The set of instructions, when executed by one or more processors of the UE, may cause the UE to transmit a reconfiguration error message that indicates the configuration error.

Some aspects described herein relate to a non-transitory computer-readable medium that stores a set of instructions for wireless communication by a network node. The set of instructions, when executed by one or more processors of the network node, may cause the network node to transmit a reconfiguration message that includes a configuration error. The set of instructions, when executed by one or more processors of the network node, may cause the network node to receive a reconfiguration error message that indicates the configuration error.

Some aspects described herein relate to an apparatus for wireless communication. The apparatus may include means for receiving a reconfiguration message that includes a configuration error. The apparatus may include means for transmitting a reconfiguration error message that indicates the configuration error.

Some aspects described herein relate to an apparatus for wireless communication. The apparatus may include means for transmitting a reconfiguration message that includes a configuration error. The apparatus may include means for receiving a reconfiguration error message that indicates the configuration error.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of a wireless communication process, in accordance with the present disclosure.

FIG. 5 is a diagram illustrating an example of a wireless communication process between a network node and a UE, in accordance with the present disclosure.

FIG. 6 is a diagram illustrating an example of a wireless communication process between a network node and a UE, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network node or an apparatus of a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A network node may configure various parameters and/or resources that are used by a user equipment (UE) to communicate in a wireless communication (e.g., transmission configuration parameters, reception configuration parameters, and/or air interface resource configuration parameters). Some non-limiting examples of such parameters and/or resources may include a frequency band, a modulation and coding scheme (MCS), a transmission power level, a type of reconfiguration being performed (e.g., a cell reconfiguration or a handover), a measurement configuration (e.g., what measurement to perform and/or what air interface resources to use for performing the measurement), quality of service (QOS) parameter(s), neighboring cell information, timer values, cell selection parameter and/or reselection parameters (e.g., parameters on how to evaluate a cell for selection), reference signal configuration parameters, radio link control parameters, and/or medium access control (MAC) parameters, among other examples. Accordingly, the network node may transmit configuration information to the UE, and the configuration information may specify the selected parameters and/or resources.

At times, a network node may transmit configuration information that includes a configuration error. For example, the network node may indicate, via the configuration information, a combination of parameter values and/or resource selections that violate one or more conditions that are specified by a communication standard, an incorrect combination of frequency bands (e.g., incompatible frequency bands, undefined frequency bands, and/or a combination of frequency bands that violate a communication standard condition), an incorrect protocol layer parameter (e.g., incorrect Layer 1, Layer 2, and/or Layer 3 parameters), an incorrect combination of settings (e.g., incompatible settings, undefined settings, and/or a combination of settings that violate a communication standard condition), an incorrect value (e.g., an incompatible combination of values, an out-of-range value, and/or a combination of values that violate a communication standard condition), and/or a capability incompatibility (e.g., a setting and/or value that is incompatible with a UE capability). Alternatively, or additionally, the network node may transmit configuration information that is missing a configuration parameter, such as a parameter that a communication standard specifies should be included in the configuration information. At times, the configuration error may result in one or more failures at the UE, such as a radio link failure (RLF). The UE may respond to the configuration error by refraining from transmitting a message that confirms the configuration information and/or by applying prior configuration information that does not include the configuration error. Accordingly, the UE may not provide information to the network node that specifies details about the configuration error observed at the UE.

With increasing device capabilities and/or increasing features being added to a communication standard from release to release, the parameters and/or settings that are included in configuration information may also increase. An increased number of parameters and/or settings in configuration information may result in an increase in the potential that a network node transmits configuration information that includes a configuration error. Debugging a configuration error may delay development of, and/or upgrades to, a network node and/or a UE. As further described below, a debugging process and/or resolution process may include multiple steps that span several days, several weeks, and/or several months. During this time span, a UE may continue to experience failure(s) while operating in the wireless network. Alternatively, or additionally, a network node may iteratively transmit the configuration information that includes the configuration error to the UE, resulting in needless power consumption at the UE and/or a reduced battery life at the UE. For example, the UE may drain power resources by operating in a continuous loop of processing configuration errors that are iteratively transmitted by the network node.

Various aspects relate generally to provide dynamic configuration error messaging. Some aspects more specifically relate to a UE autonomously transmitting an indication of a configuration error to a network node. In some aspects, a UE may receive a reconfiguration message that includes a configuration error in configuration information. To illustrate, the UE may receive a radio resource control (RRC) reconfiguration message as part of a handover and/or a connection setup procedure, and the RRC reconfiguration message may indicate configuration information that includes a configuration error, examples of which are provided below. Based at least in part on identifying the configuration error in the configuration information, the UE may transmit a reconfiguration error message that indicates the configuration error. The transmission of a reconfiguration error message may alternatively be referred to as configuration failure messaging. “Dynamic configuration failure messaging” may denote a UE autonomously detecting a configuration error and/or the UE autonomously transmitting an indication of the configuration error, and “configuration error” may denote an error in configuration information (e.g., configuration information that indicates parameters and/or resources as described above).

In some aspects, a network node may transmit a reconfiguration message that includes a configuration error, and the network node may receive a reconfiguration error message that indicates the configuration error. At times, the network node may decode the configuration error using the reconfiguration error message and/or may perform an action that corrects the configuration error, such as by transmitting updated configuration information that corrects the configuration error (e.g., by including a missing parameter, by changing incompatible frequency bands, by changing an incorrect protocol layer parameter, and/or by removing a capability incompatibility).

Particular aspects of the subject matter described in this disclosure can be implemented to realize one or more of the following potential advantages. In some examples, by transmitting a reconfiguration error message, the described techniques can be used to enable a UE to provide a notification of a configuration error and/or detailed information about the configuration error. Providing information about a configuration error may reduce an amount of time used in a debugging process and/or resolution process that corrects the configuration error. Reducing an amount of time spent in a debugging process and/or resolution process may reduce a time span that a UE continues to experience one or more configuration errors and/or failures. That is, the network node may identify a configuration error more quickly, relative to not using a reconfiguration error message, and may reduce an amount of time that a UE observes a configuration error and/or a reconfiguration failure. Alternatively, or additionally, the network node identifying the configuration error more quickly may reduce an amount of time that the UE experiences a connection failure. Reducing an amount of time spent in a debugging process and/or resolution process may reduce a time span in which a network node iteratively transmits the configuration error to the UE, and reducing a time span that the network node iteratively transmits the configuration may reduce power consumption at the UE and/or may increase a battery life at the UE (e.g., by reducing the UE iteratively processing configuration errors). In some aspects, the reconfiguration error message may be configured to indicate a large variety of configuration errors (e.g., 500+ different configuration errors), such as through the use of a string that may be set to a custom value, without a communication standard defining each particular configuration error.

The transmission of a reconfiguration error message may alternatively or additionally enable a network operator to disable a network node that is transmitting one or more configuration errors. For example, the network operator may transition the network node to an enabled network energy saving (NES) mode that results in the network node operating in a sleep mode that disables transmission and/or reception by the network node. Transitioning the network node to an enabled NES mode may reduce the transmission of configuration errors in a wireless network, reduce connection errors at a UE, and/or reduce power consumption at the UE.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

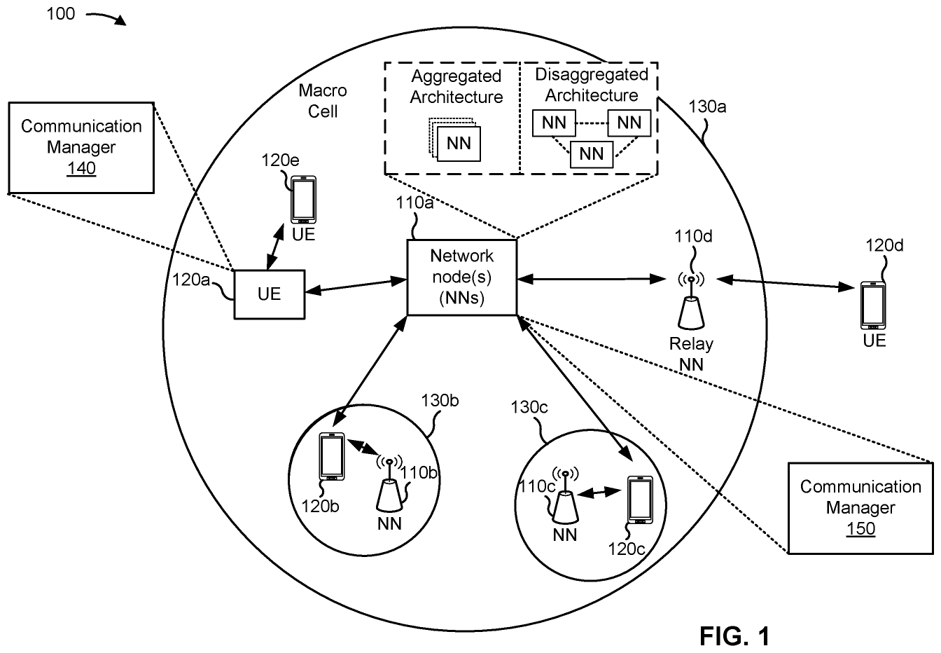

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/long term evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., a UE 120) may include a communication manager 140. As described in more detail elsewhere herein, the communication manager 140 may receive a reconfiguration message that includes a configuration error; and transmit a reconfiguration error message that indicates the configuration error. Additionally, or alternatively, the communication manager 140 may perform one or more other operations described herein.

In some aspects, a network node (e.g., a network node 110) may include a communication manager 150. As described in more detail elsewhere herein, the communication manager 150 may transmit a reconfiguration message that includes a configuration error; and receive a reconfiguration error message that indicates the configuration error. Additionally, or alternatively, the communication manager 150 may perform one or more other operations described herein.

As indicated above, FIG. 1 is provided as an example. Other examples may differ from what is described with regard to FIG. 1.

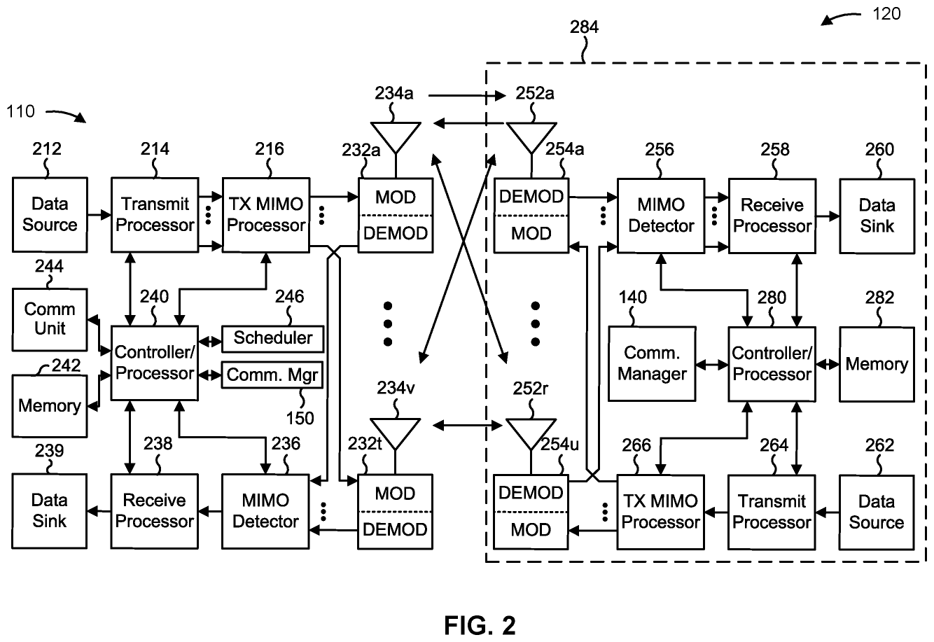

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

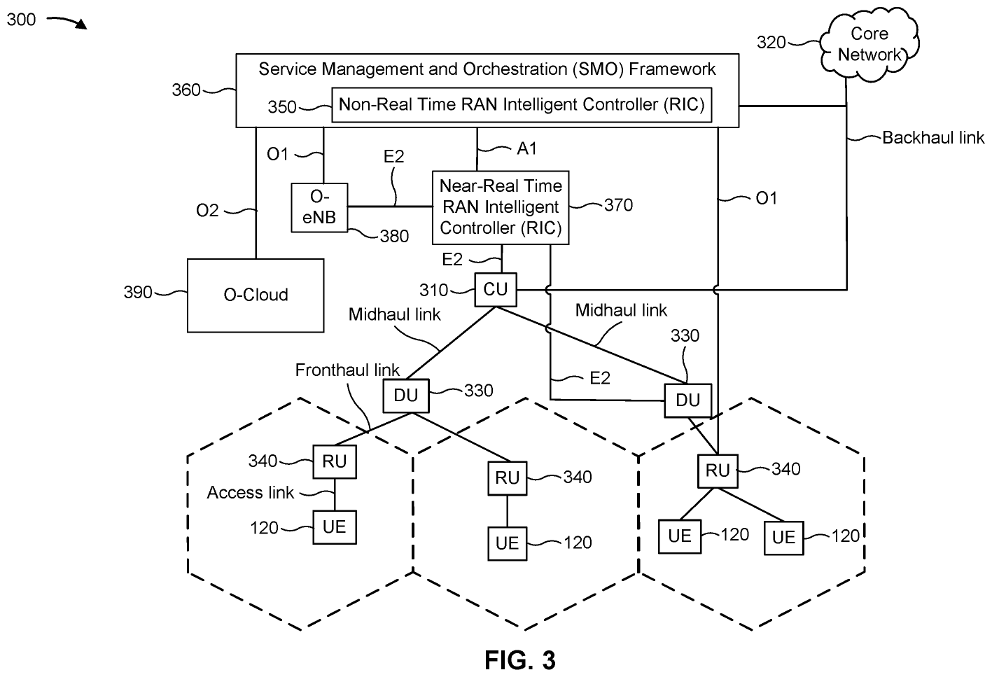

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as AI interface policies).

As indicated above, FIG. 3 is provided as an example. Other examples may differ from what is described with regard to FIG. 3.

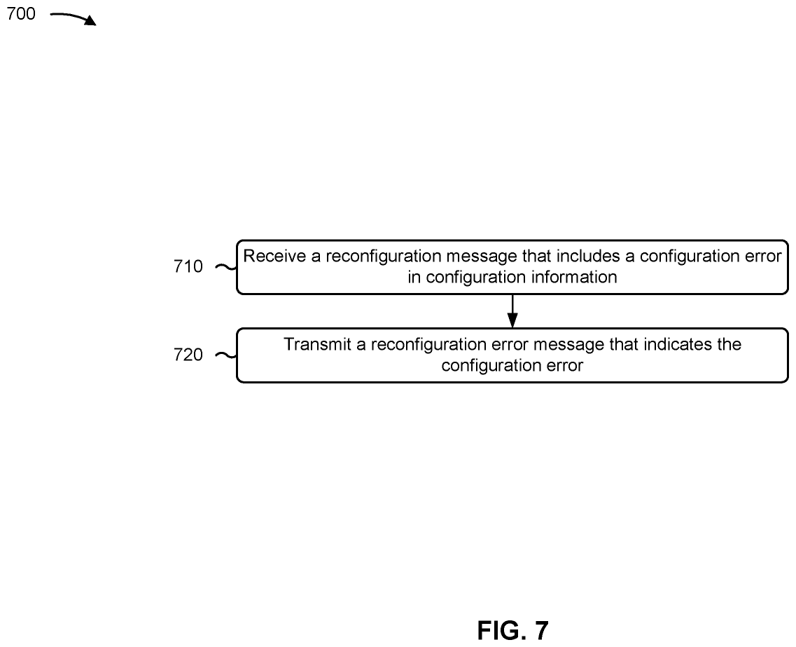

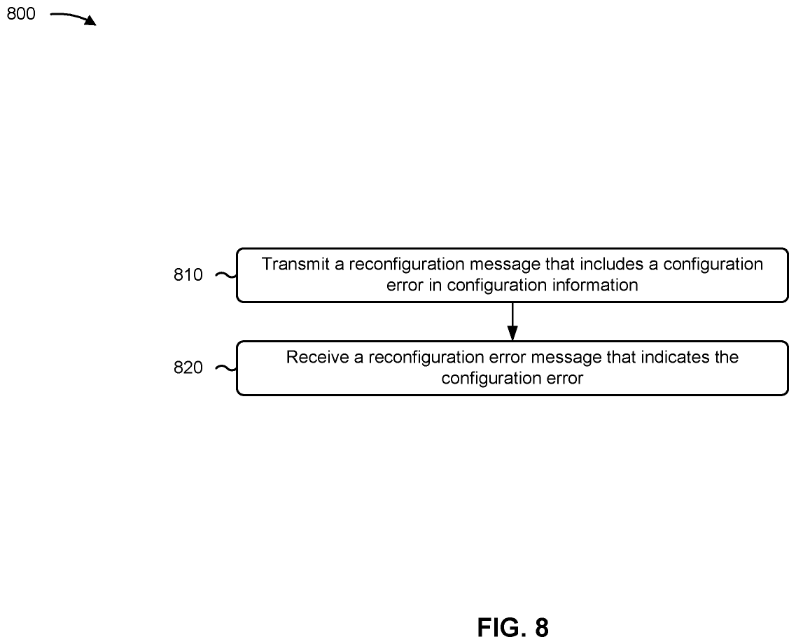

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with dynamic configuration failure messaging, as described in more detail elsewhere herein. “Dynamic configuration failure messaging” may denote a UE autonomously detecting a configuration error and/or the UE autonomously transmitting an indication of the configuration error, and “configuration error” may denote an error in configuration information (e.g., configuration information that specifies various parameters and/or resources as described above, such as any combination of transmission configuration parameters, reception configuration parameters, and/or air interface resource configuration parameters). For example, the controller/processor 240 of the network node 110, the controller/processor 280 of the UE 120, any other component(s) of FIG. 2, the CU 310, the DU 330, or the RU 340 may perform or direct operations of, for example, process 700 of FIG. 7, process 800 of FIG. 8, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

In some aspects, a UE (e.g., a UE 120) includes means for receiving a reconfiguration message that includes a configuration error; and/or means for transmitting a reconfiguration error message that indicates the configuration error. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., a network node 110) includes means for transmitting a reconfiguration message that includes a configuration error; and/or means for receiving a reconfiguration error message that indicates the configuration error. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

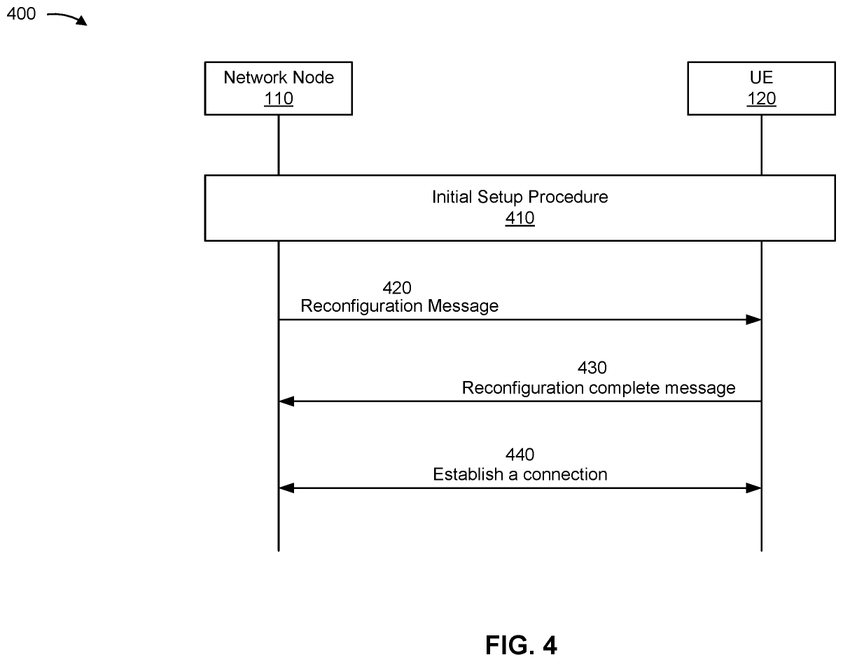

FIG. 4 is a diagram illustrating an example 400 of a wireless communication process, in accordance with the present disclosure.

A network node 110 may configure various parameters and/or resources that are used by a UE 120 to communicate in a wireless communication (e.g., transmission configuration parameters, reception configuration parameters, and/or air interface resource configuration parameters). The network node 110 managing and/or controlling the parameters and/or resources used by the UE 120 may increase a reliability of a connection between the network node 110 and the UE 120 by reducing recovery errors, increasing data throughput, and/or decreasing data transfer latencies. Some non-limiting examples of parameters and/or resources may include a frequency band, a modulation and coding scheme (MCS), a transmission power level, a type of reconfiguration being performed (e.g., a cell reconfiguration or a handover), a measurement configuration (e.g., what measurement to perform and/or what air interface resources to use for performing the measurement), quality of service (QOS) parameter(s), neighboring cell information, timer values, and/or cell selection and/or reselection parameters (e.g., parameters on how to evaluate a cell for selection). As one example, the network node 110 may select parameters and/or resources that mitigate a transmission collision in a communication that is directed to the UE and/or received from the UE. As another example, the network node 110 may select parameters and/or resources that improve a signal quality (e.g., increase a signal power level, reduce interference, and/or increase data throughput) based at least in part on channel conditions. In some aspects, the network node 110 may select parameters and/or resources that enable UE communications to satisfy a QoS condition at the UE 120.

The example 400 shown in FIG. 4 is an example procedure that may be performed by a network node 110 and a UE 120 to establish a connection with one another. As part of establishing a connection with the UE 120, the network node 110 may indicate configuration information (e.g., parameters and/or resources) to the UE 120. To illustrate, and as shown by reference number 410, the network node 110 and the UE 120 may perform an initial setup procedure. For instance, as part of the initial setup procedure, the network node may transmit one or more synchronization signals (e.g., a PSS, an SSS, and/or a synchronization signal block (SSB)), and the UE may decode information included in any combination of the PSS, the SSS, and/or the SSB to identify frame timing and/or system information associated with the network node 110. In some aspects, the network node 110 and the UE 120 may perform, as part of the initial setup procedure, a random access procedure and/or may establish an initial RRC connection.

As shown by reference number 420, the network node 110 may transmit, and the UE 120 may receive, a reconfiguration message. As one example, the network node 110 may transmit an RRC reconfiguration message that is specified by a communication standard. That is, the communication standard may specify one or more parameters and/or resources to include in the RRC reconfiguration message. In some aspects, the reconfiguration message may include configuration information through the use of one or more information elements (IEs), and the IEs may indicate any combination of parameters and/or resources, such as any combination of transmission configuration parameters, reception configuration parameters, and/or air interface resource configuration parameters as described above. For clarity, FIG. 4 illustrates the network node 110 transmitting the reconfiguration message separately from performing the initial setup procedure, but in other examples, the network node may transmit the reconfiguration message as part of the initial setup procedure. In some aspects, the transmission of a reconfiguration message (e.g., an RRC reconfiguration message) may indicate an instruction to perform a reconfiguration process using the parameter(s) and/or resources included in the reconfiguration message.

As shown by reference number 430, the UE 120 may transmit, and the network node 110 may receive, a reconfiguration complete message. As one example, the UE 120 may transmit an RRC reconfiguration complete message (e.g., specified by a communication standard) to acknowledge receipt of a reconfiguration message and/or completion of a reconfiguration process. In some aspects, the transmission of an RRC reconfiguration complete message may indicate successful completion of the reconfiguration process.

As shown by reference number 440, the network node 110 and the UE 120 may establish a connection. In some aspects, the network node 110 and the UE 120 may establish the connection using configuration information indicated in the reconfiguration message, such as by using frequency bands, MCSs, and/or timers as specified by the configuration information.

In some aspects, a network node (e.g., a network node 110) may transmit a reconfiguration message and/or configuration information that includes a configuration error (e.g., the reconfiguration message includes configuration information, and the configuration information includes a configuration error). For example, the network node may indicate, via the configuration information, a combination of parameter values and/or resource selections that violate one or more conditions that are specified by a communication standard, an incorrect combination of frequency bands (e.g., incompatible frequency bands, undefined frequency bands, and/or a combination of frequency bands that violate a communication standard condition), an incorrect protocol layer parameter (e.g., incorrect Layer 1, Layer 2, and/or Layer 3 parameters), an incorrect combination of settings (e.g., incompatible settings, undefined settings, and/or a combination of settings that violate a communication standard condition), an incorrect value (e.g., an incompatible combination of values, an out-of-range value, and/or a combination of values that violate a communication standard condition), and/or a capability incompatibility (e.g., a setting and/or value that is incompatible with a UE capability). Alternatively, or additionally, the network node may transmit a reconfiguration message and/or configuration information that is missing a configuration parameter (e.g., a parameter that a communication standard specifies to include in the reconfiguration message and/or the configuration information). The UE may respond to the configuration error by refraining from transmitting a reconfiguration configuration message and/or by using a prior set of parameters and/or resources that do not include a configuration error. Accordingly, the UE may not provide information that specifies details about the configuration error observed at the UE. In some aspects, the configuration error may result in one or more failures at the UE, such as a radio link failure (RLF).

With increasing device capabilities and/or increasing features being added to a communication standard from release to release, the parameters and/or settings that are included in a reconfiguration message and/or configuration information may also increase. An increased number of parameters and/or settings in a reconfiguration message may result in an increase in opportunities for a network node to transmit configuration information that includes a configuration error and/or results in a reconfiguration failure. Accordingly, the addition of new features supported and/or specified by a communication standard may result in an increase in configuration errors that are observed by a UE. To illustrate, a network operator may perform iterative and/or periodic upgrades to a network node to incorporate new features and/or support for new conditions specified by a communication standard, and the upgrades may include errors that result in the network node transmitting, and the UE receiving, configuration errors.

Debugging a configuration error may delay development of, and/or upgrades to, a network node and/or a UE. As one example, a debugging and/or resolution process may entail an original equipment manufacturer (OEM), such as a UE manufacturer, testing a UE in a wireless network and observing a failure at a chipset that is included in the UE while the UE operating in the wireless network. The OEM may submit a report of the failure to a chipset vendor of the chipset that is included in the UE. Alternatively, or additionally, the OEM may submit the report of the failure to a network operator that is associated with the wireless network used by the OEM to generate the failure. In some aspects, the network operator may request additional information about the failure, resulting in the OEM requesting more information about the failure from the chipset vendor, such as a technical memo that describes the failure. Based at least in part on receiving the information from the chipset vendor, the OEM may forward the information to the network operator to aid the network operator in debugging and resolving the failure. The multiple steps involved in the debugging and/or resolution process may span several days, several weeks, and/or several months. During this span, a UE may continue to experience failures (e.g., RLFs) while operating in the wireless network. In some aspects, a network node may continue to transmit the configuration error to the UE, even after RLF is declared by the UE, resulting in needless power consumption at the UE and/or a reduced battery life at the UE. For example, the UE may drain power resources by operating in a continuous loop of processing reconfiguration errors that are iteratively transmitted by the network node.

Some techniques and apparatuses described herein provide dynamic configuration failure messaging. In some aspects, a UE may receive a reconfiguration message that includes configuration information, and the configuration information includes a configuration error. To illustrate, the UE may receive an RRC reconfiguration message as part of a handover and/or a connection setup procedure, and the RRC reconfiguration message may indicate configuration information that includes a configuration error, such as any combination of a violation of a communication standard, an incorrect band combination, a missing configuration parameter, an incorrect combination of settings, an incorrect value, a capability incompatibility, and/or an incorrect protocol layer parameter. Based at least in part on identifying the configuration error, the UE may transmit a reconfiguration error message that indicates the configuration error. For instance, the UE may transmit a reconfiguration error message that includes a string, and the string may be set to text that describes the configuration error. For example, text included in the string may include meaningful text (e.g., text that includes information that explains the configuration error, may be used to identify the configuration error, and/or may describe a solution to the configuration error). The ability to return a particular message and/or customized text string enables the UE 120 to report a large variety of configuration errors using a common mechanism (e.g., the string) and/or without a communication standard providing an error code for each particular configuration error.

However, the reconfiguration error message may include other mechanisms to indicate the configuration error, such as a bitfield, an enumeration type, and/or a value that indicates a category of a configuration error, an index of an identified configuration error, and/or an IE type name that includes the configuration error. The transmission of a reconfiguration error message may alternatively be referred to as configuration failure messaging. As described above, “dynamic configuration failure messaging” may denote a UE autonomously detecting a configuration error and/or the UE autonomously transmitting an indication of the configuration error, and “configuration error” may denote an error in configuration information (e.g., configuration information that specifies various parameters and/or resources, such as any combination of transmission configuration parameters, reception configuration parameters, and/or air interface resource configuration parameters as described above).

In some aspects, a network node may transmit a reconfiguration message that includes a configuration error, and the network node may receive a reconfiguration error message that indicates the configuration error. At times, the network node may decode the configuration error using the reconfiguration error message and/or may perform an action that corrects the configuration error, such as by transmitting updated configuration information that corrects the configuration error (e.g., by including a missing parameter, by changing incompatible frequency bands, by changing an incorrect protocol layer parameter, by removing a capability incompatibility, by disabling a cell, and/or by switching the cell off).

The transmission of a reconfiguration error message may enable a UE to provide a notification of a configuration error (e.g., a configuration failure) and/or detailed information about the configuration error. Providing information about a configuration error may reduce an amount of time used in a debugging process and/or resolution process that corrects the configuration error. Reducing an amount of time spent in a debugging process and/or resolution process may reduce a time span that a UE continues to experience configuration error(s) and/or failure(s). That is, the network node may identify a configuration error more quickly, relative to not receiving the reconfiguration error message, and reduce an amount of time during which a UE observes a configuration error and/or a reconfiguration failure. Alternatively, or additionally, the network node identifying the configuration error more quickly may reduce an amount of time that the UE experiences a connection failure, such as an RLF. Reducing an amount of time spent in a debugging process and/or resolution process may reduce a time span in which a network node iteratively transmits the configuration error to the UE, and reducing a time span in which the network node iteratively transmits the configuration may reduce power consumption at the UE and/or may increase a battery life at the UE (e.g., by reducing the UE iteratively processing configuration errors). In some aspects, the reconfiguration error message may be configured to indicate a large variety of configuration errors (e.g., 500+ different configuration errors), such as through the use of a string that may be set to a custom value, without a communication standard defining each particular configuration error. As one example, the custom value of the string may include meaningful text (e.g., text that includes information that explains the configuration error, may be used to identify the configuration error, and/or may describe a solution to the configuration error). The string may alternatively, or additionally, be formatted in any suitable language, such as Chinese, Spanish, English, Hindi, Portuguese, Japanese, French, and/or German. The ability to return a particular message and/or customized text string enables the UE to report a large variety of configuration errors using a common mechanism (e.g., the string) and/or without a communication standard providing an error code for each particular configuration error.

The transmission of a reconfiguration error message may alternatively or additionally enable a network operator to disable a network node that is transmitting configuration errors. For example, the network operator may transition the network node to an enabled NES mode that results in the network node operating in a sleep mode that disables transmission and/or reception by the network node. Transitioning the network node to an enabled NES mode may reduce the transmission of configuration errors in a wireless network, reduce connection errors at a UE, and/or reduce power consumption at the UE.

As indicated above, FIG. 4 is provided as an example. Other examples may differ from what is described with regard to FIG. 4.

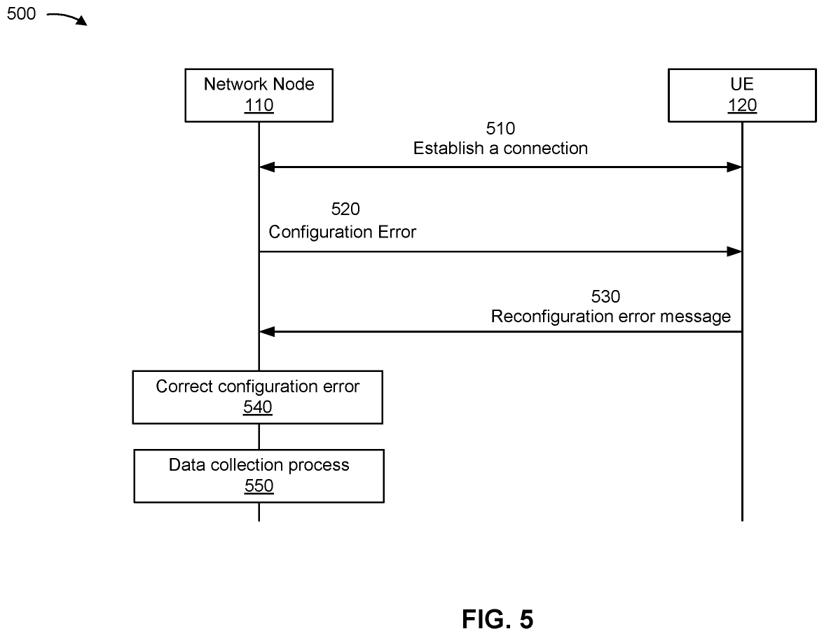

FIG. 5 is a diagram illustrating an example 500 of a wireless communication process between a network node (e.g., the network node 110) and a UE (e.g., the UE 120), in accordance with the present disclosure.

As shown by reference number 510, a network node 110 and a UE 120 may establish a connection. To illustrate, the UE 120 may power up in a cell coverage area provided by the network node 110, and the UE 120 and the network node 110 may perform one or more procedures (e.g., a random access channel (RACH) procedure and/or an RRC procedure) to establish a wireless connection. As another example, the UE 120 may move into the cell coverage area provided by the network node 110 and may perform a handover from a source network node (e.g., another network node 110) to the network node 110. Alternatively, or additionally, the network node 110 and the UE 120 may communicate via the connection based at least in part on any combination of Layer 1 signaling (e.g., downlink control information (DCI) and/or uplink control information (UCI)), Layer 2 signaling (e.g., a MAC control element (CE)), and/or Layer 3 signaling (e.g., RRC signaling). To illustrate, the network node 110 may request, via RRC signaling, UE capability information and/or the UE 120 may transmit, via RRC signaling, the UE capability information. As part of communicating via the connection, the network node 110 may transmit configuration information via Layer 3 signaling (e.g., RRC signaling), and activate and/or deactivate a particular configuration via Layer 2 signaling (e.g., a MAC CE) and/or Layer 1 signaling (e.g., DCI). To illustrate, the network node 110 may transmit the configuration information via Layer 3 signaling at a first point in time associated with the UE being tolerant of communication delays, and the network node 110 may transmit an activation of the configuration via Layer 2 signaling and/or Layer 1 signaling at a second point in time associated with the UE being intolerant to communication delays.

As shown by reference number 520, the network node 110 may transmit, and the UE 120 may receive, a configuration error. As one example, the network node 110 may transmit a reconfiguration message (e.g., an RRC reconfiguration message) that includes configuration information, and the configuration information may include the configuration error. Some non-limiting examples of configuration errors may include a violation of a communication standard, an incorrect band combination, a missing configuration parameter, an incorrect combination of settings, an incorrect value, a capability incompatibility, and/or an incorrect protocol layer parameter. While FIG. 5 illustrates the network node 110 transmitting the configuration error separately from establishing a connection with the UE 120, some examples may include the network node 110 transmitting the configuration error as part of establishing the connection with the UE 120.

As shown by reference number 530, the UE 120 may transmit, and the network node 110 may receive, a reconfiguration error message. As one example, the reconfiguration error message may be an RRC reconfiguration error message that indicates the configuration error. In some aspects, the reconfiguration error message may include a string, and the string may indicate the configuration error. An example of a reconfiguration error string is as follows:

RRCReconfigurationFailure::=SEQUENCE{failureCause String[256],}

Using a string to indicate a configuration error and, subsequently, a reconfiguration failure, may provide flexibility to the UE 120 to report a variety of errors.

To illustrate, configuration information, such as configuration information indicated by an RRC reconfiguration message, may include multiple parameters, multiple settings, and/or multiple values as described above, such that a variety of configuration errors may exist (e.g., a communication standard violation, an incorrect band combination, a missing configuration parameter, an incorrect combination of settings, an incorrect value, a capability incompatibility, and/or an incorrect protocol layer parameter). That is, the number of possible configuration errors may be extensive to a degree that makes specifying a respective error code for each respective configuration error difficult and/or extensive. Using a string to indicate a configuration error may enable the UE 120 to customize a particular message (e.g., a text string customized by the UE 120 and/or a text string that is not specified by a communication standard) that provides detail on a particular configuration error. For example, the customized string may include meaningful text that explains the configuration error, may be used to identify the configuration error, and/or may describe a solution to the configuration error. The ability to return a particular message and/or customized text string enables the UE 120 to report a large variety of configuration errors using a common mechanism (e.g., the string) and/or without a communication standard providing an error code for each particular configuration error.

As one example, the configuration information may erroneously exclude and/or fail to provide a bandwidth of a target cell for a handover in mobility parameters for the UE 120. Accordingly, the UE 120 may indicate a configuration error by setting the string to “No bandwidth provided.” As another example, the configuration information may include an incorrect sounding reference signal (SRS) configuration, and the UE 120 may set the string to “Wrong SRS configuration.” Alternatively, or additionally, the UE 120 may indicate an exact error, such as “Wrong SRS configuration of ‘1T4R” by a UE that does not support 1T4R (e.g., an antenna and/or port switching configuration). As yet another example, the configuration information may include an incorrect protocol configuration, such as the network node 110 transmitting configuration information that configures LTE PDCP when NR PDCP is already configured. In some aspects, the UE 120 may respond to the incorrect protocol configuration by refraining from configuring LTE PDCP and setting the string to “LTE PDCP not configured.” In other aspects, the UE 120 may respond to the incorrect protocol configuration by configuring LTE PDCP (and/or releasing NR PDCP) and setting the string to “LTE PDCP configured, NR PDCP released.”

In some aspects, a size of the string may be bounded (e.g., may have a maximum allowed size). For instance, a communication standard may specify the maximum allowed size of the string that is permissible. The use of a maximum allowed size may mitigate the UE 120 transmitting a reconfiguration error message with a size that results in the UE 120 using a disproportionate amount of air interface resources in a wireless network. For example, a disproportionate amount of air interface resources may be an amount of air interface resources that delays other communications in the wireless network by latency that results in failures at other UEs. However, in other aspects, the allowed size of the string may be undefined and/or unbounded (e.g., no maximum allowed size is defined) such that the UE 120 may transmit a string of any size.

As described above, the UE 120 may set the string to a customized value and/or a unique value (e.g., a customized string and/or unique string), such as meaningful text as described above. In other aspects, the UE 120 may select a string value from multiple preconfigured string values. For instance, a communication standard may specify, as the multiple preconfigured string values, a respective string value for a respective configuration error category, such as “Standard Violation Category”, “Incompatible Bands Category”, “Capability Incompatibility Category”, “Missing Setting Category”, “Incorrect Setting Combination Category” and/or “Incorrect Protocol Setting Category”, and each category may map to multiple configuration errors. Accordingly, the UE 120 may select a particular preconfigured string value (e.g., a category string value) from the multiple preconfigured string values, and set the string in the reconfiguration error message to the particular preconfigured string value. However, and as described above, the UE 120 may set the string to a custom string value and/or custom string text, such as text that described and/or explains the error and/or may be used to identify the configuration error. For instance, a custom string may indicate a particular IE name that includes a configuration error, a particular name of a setting that includes a configuration error, and/or a particular value that is incorrect. The ability to return a particular message and/or customized text string enables the UE 120 to report a large variety of configuration errors using a common mechanism (e.g., the string) and/or without a communication standard providing an error code for each particular configuration error.

Alternatively, or additionally, the reconfiguration error message may include other mechanisms to indicate a configuration error. As one example, the reconfiguration error message may include a bitfield, and each bit of the bitfield may correspond to a respective configuration error category, such as the configuration error categories described above with regard to the multiple preconfigured string values. The use of a bitfield may reduce a size of the reconfiguration error message and conserve air interface resources. As another example, the reconfiguration error message may include an enumeration field that may be configured to include a variety of enumeration values that each map to a respective configuration error category. In some aspects, the reconfiguration error message may include a first mechanism to indicate a configuration error category, such as a bitfield and/or an enumeration field, and a second mechanism, such as a string, to indicate detailed information about a particular configuration error that may be classified by the configuration error category, such as an IE name, a setting name, and/or a setting value. In some aspects, the reconfiguration error message may include an IE that indicates the configuration error and/or additional information. For instance, the IE may include one or more fields and/or parameters, such as a string and/or an enumeration field, that may be used to provide information about the configuration error.

The UE 120 may transmit, in reconfiguration error message, an indication of an action performed based at least in part on the configuration error. Some non-limiting examples of actions that may be performed by the UE 120 include an RLF procedure, a cell barring procedure, application of the configuration error, and/or application of prior configuration information that does not include a configuration error. In some aspects, the UE 120 may indicate the action using a string (e.g., a same string that indicates the configuration error and/or a separate string from a configuration error string), while in other aspects, the UE 120 may indicate the action using a separate mechanism than a string, such as a bitfield and/or an enumeration field.

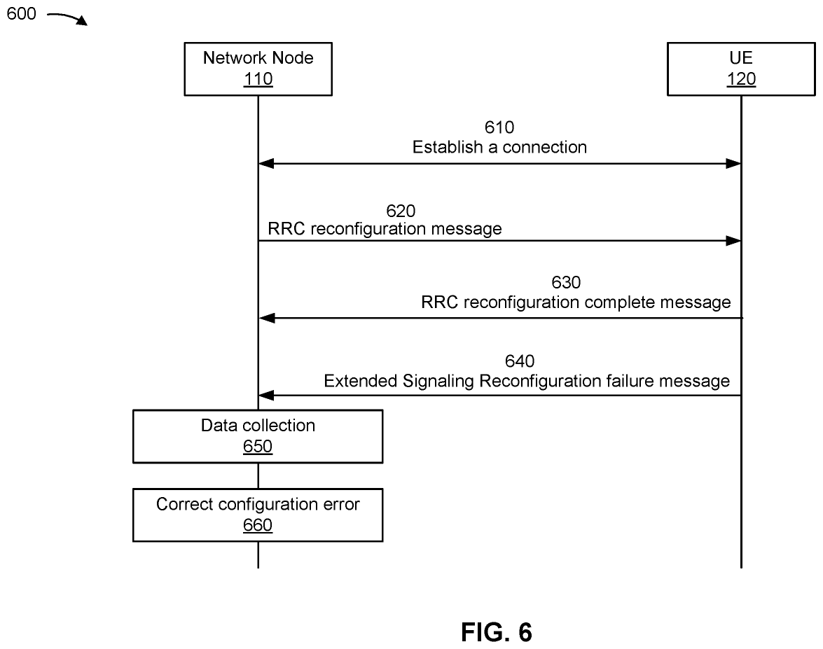

In some aspects, the reconfiguration error message may be specified by a communication standard, such as a communication standard that is specified by a governing committee through a collaborative process to ensure interoperability of wireless communications between different UEs (e.g., UEs manufactured by different OEMs) and different network operators. Accordingly, such a reconfiguration error message may be adopted and/or implemented by an industry that includes different and/or unrelated entities. In other aspects, the reconfiguration error message may be specified by a network operator and/or an OEM. That is, the reconfiguration error message may be a proprietary message specified by the network operator, rather than a communication standard. “Extended signaling” may denote wireless signaling, such as Layer 1 signaling, Layer 2 signaling, and/or Layer 3 signaling, that is proprietary to, and/or specified by, a particular entity, such as a network operator and/or a governing body of the network operator, that is not adopted by an industry and/or is not specified by a communication standard for interoperability. That is, “extended signaling” may denote signaling that does not need to be implemented by a device in order to be compliant with a communication standard. Accordingly, the UE 120 may transmit the reconfiguration error message using signaling that is specified by a communication standard, and/or may transmit the reconfiguration error message using extended signaling. An example of extended signaling is described below with regard to FIG. 6.

As shown by reference number 540, the network node 110 may correct the configuration error, and correcting the configuration error may include a variety of actions by the network node. In some aspects, the network node 110 may automatically trigger detecting and/or correcting the configuration error, while in other aspects, the network node 110 may be manually triggered (e.g., by a network operator) to detect and/or correct the configuration error. As one example, the network node 110 may include machine learning capabilities that are trained to decode and/or map a string into a configuration error. That is, the machine learning capabilities may enable the network node 110 to automatically decode the string, identify a reason for failure, and/or identify a configuration error. In other aspects, a network operator may manually decode the string and/or manually identify the configuration error. One example of correcting the configuration error may include the network node 110 transmitting updated configuration information (e.g., via an updated reconfiguration message) that corrects the configuration error.

As one example of an action performed by the network node 110, and based at least in part on receiving a string set to “No bandwidth provided” in the reconfiguration error message, the network node 110 may use machine learning capabilities to parse through the configuration information to locate a position of the missing bandwidth in the configuration information and/or to add the missing bandwidth to updated configuration information. In some aspects, the network node 110 may autonomously and/or automatically trigger the parsing and/or correction, while in other aspects, a network operator may manually trigger the parsing and/or correction. Alternatively, or additionally, a network operator may manually locate and/or correct the missing bandwidth information, such as by updating firmware at the network node 110. As described above, the network node 110 may transmit updated configuration information that corrects the configuration error.

As another example, and based at least in part on receiving a “Wrong SRS configuration” message, the network node 110 may perform a calibration procedure (e.g., autonomously triggered, automatically triggered, and/or manually triggered by a network operator) to verify an operating state of the network node 110 that may affect the SRS configuration. As one example, the network node may analyze a UE indicated by the UE 120 (e.g., in UE capability information) and/or the configuration information to confirm whether the configuration information includes one or more configurations that are unsupported by the UE. For instance, the UE 120 may indicate support for a first antenna and/or antenna port switching configuration (e.g., 1T2R) and the network node 110 may detect that the configuration information indicates a second antenna and/or antenna port switching configuration (e.g., 1T4R). As another example, the network node 110 May compare one or more band combinations in the configuration information based at least in part the UE capability information to validate if a band combination in the configuration is supported by the UE 120.

As shown by reference number 550, the network node 110 may perform a data collection process based at least in part on receiving the reconfiguration error message. For example, as part of the data collection process, the network node 110 may forward configuration information that includes a configuration error and/or the reconfiguration error message to a server and/or core network node. In some aspects, the server and/or core network node may train a machine learning model and/or algorithm, using the configuration information that includes the configuration error and/or the reconfiguration error message, to identify a configuration error and/or resolution to the configuration error. Alternatively, or additionally, a machine learning algorithm at the network node 110 may be updated (e.g., manually or autonomously) based at least in part on the training performed at the core network node and/or the server. In other aspects, the network node 110 may locally train a machine learning model and/or algorithm using the configuration information that includes the configuration error and/or the reconfiguration error message. The network node 110 performing a data collection process may enable the network node 110 to prioritize error correction. For instance, based at least in part on receiving a similar and/or same configuration error message from multiple UEs, the network node 110 may prioritize a fix to the configuration error.

The transmission of a reconfiguration error message may enable a UE to provide a notification of a configuration error and/or detailed information about the configuration error. Providing information about a configuration error may reduce an amount of time used in a debugging process and/or resolution process that corrects the configuration error. Reducing an amount of time spent in a debugging process and/or resolution process may reduce a time span that a UE continues to observe configuration error(s) and/or experience connection failure(s). Alternatively, or additionally, reducing an amount of time spent in a debugging process and/or resolution process may reduce a time span in which a network node continues to transmit the configuration error to the UE, resulting in reduced power consumption at the UE and/or an increased battery life at the UE. In some aspects, the reconfiguration error message may be configured to indicate a large variety of configuration errors (e.g., 500+ different configuration errors), such as through the use of a string that may be set to a custom value, without a communication standard defining an error code for each particular configuration error.

As indicated above, FIG. 5 is provided as an example. Other examples may differ from what is described with regard to FIG. 5.

FIG. 6 is a diagram illustrating an example 600 of a wireless communication process between a network node (e.g., the network node 110) and a UE (e.g., the UE 120), in accordance with the present disclosure. In some aspects, the example 600 includes the UE and the network node communicating with one another based at least in part on using extended signaling.

As shown by reference number 610, a network node 110 and a UE 120 may establish a connection using one or more techniques described with regard to reference number 510.

As shown by reference number 620, the network node 110 may transmit, and the UE 120 may receive, an RRC reconfiguration message that is specified by a communication standard, such as a 4G communication standard, a 5G communication standard, and/or a 6G communication standard. In some aspects, the communication standard may specify a configuration of the RRC reconfiguration message based at least in part on specifying any combination of an IE, a parameter, and/or a setting that is included in the RRC reconfiguration message. Alternatively, or additionally, the communication standard may specify a protocol layer to use for transmitting and/or receiving the RRC reconfiguration message. Accordingly, to be compliant with the communication standard, the network node 110 and/or the UE 120 may transmit and/or receive the RRC configuration message using the configuration and/or protocol layer specified by the communication standard. In some aspects, the reconfiguration message transmitted by the network node 110 may indicate configuration information, and the configuration information may include a configuration error in a similar manner as described with regard to reference number 520.

As shown by reference number 630, the UE 120 may transmit, and the network node 110 may receive, an RRC reconfiguration complete message. In some aspects, the RRC reconfiguration complete message may be specified by a same communication standard that specifies the RRC reconfiguration message, and the communication standard may specify a configuration of the RRC reconfiguration complete message by specifying any combination of an IE, a parameter, and/or a setting to include in the RRC reconfiguration complete message. Alternatively, or additionally, the communication standard may specify a protocol layer to use for transmitting and/or receiving the RRC reconfiguration complete message.

As shown by reference number 640, the UE 120 may transmit, and the network node 110 may receive, a reconfiguration error message using one or more techniques described with regard to reference number 530. In some aspects, the UE 120 may transmit the reconfiguration error message using extended signaling. For example, a configuration of the reconfiguration error message may not be specified by the communication standard that specifies the RRC reconfiguration message and/or the RRC reconfiguration complete message. In some aspects, a configuration of the reconfiguration error message and/or a protocol layer to use to transmit and/or receive the reconfiguration error message may be specified by a network operator associated with the network node 110 (and/or a governing organization of the network operator). To illustrate, the network operator may specify any combination of an IE, a parameter, and/or a setting to include in the reconfiguration error message, such as any combination of a string, a bitfield, and/or an enumeration field as described above. Alternatively, or additionally, the network operator may specify to transmit and/or receive the reconfiguration message using any combination of Layer 1 signaling, Layer 2 signaling, and/or Layer 3 signaling. Based at least in part on the reconfiguration error message being extended signaling and/or specified by a network operator, rather than a communication standard, a UE and/or a network node may be compliant with the communication standard without implementing the reconfiguration error message.

As shown by reference number 650, the network node 110 may perform a data collection process based at least in part on receiving the reconfiguration error message. For example, as part of the data collection process, the network node 110 may forward configuration information that includes a configuration error as described with regard to reference number 620 and/or the reconfiguration error message to a server and/or core network node. In some aspects, the server and/or core network node may train a machine learning model and/or algorithm, using the configuration information that includes the configuration error and/or the reconfiguration error message, to identify a configuration error and/or resolution to the configuration error. Alternatively, or additionally, a machine learning algorithm at the network node 110 may be updated (e.g., manually or autonomously) based at least in part on the training performed at the core network node and/or the server. In other aspects, the network node 110 may locally train a machine learning model and/or algorithm using the configuration information that includes the configuration error and/or the reconfiguration error message. The network node 110 performing a data collection process may enable the network node 110 to prioritize error correction. For instance, based at least in part on receiving a similar and/or same configuration error message from multiple UEs, the network node 110 may prioritize a fix to the configuration error.

As shown by reference number 660, the network node 110 may correct the configuration error in a similar manner as described with regard to reference number 540. As one example, the network node 110 may update the configuration information to correct the configuration error and/or may transmit the updated configuration information to the UE 120.

The use of extended signaling to indicate a reconfiguration error message may mitigate changes to a communication standard and/or may provide a network operator with the flexibility to include information in the reconfiguration error message that pertains to the network operator. Alternatively, or additionally, the use of extended signaling to indicate a reconfiguration error message may enable the network operator to update a configuration of the reconfiguration error message and/or information included in the reconfiguration error message as needs arise. In some aspects, a configuration of the reconfiguration error message may be obscured from an OEM, resulting in a reduced time span for a debugging and/or resolution process. To illustrate, a chipset in a UE manufactured by the OEM may autonomously transmit the reconfiguration error message to a network node 110, such that the OEM does not need to be involved in the debugging process as described with regard to FIG. 4

As indicated above, FIG. 6 is provided as an example. Other examples may differ from what is described with regard to FIG. 6.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with dynamic configuration failure messaging.

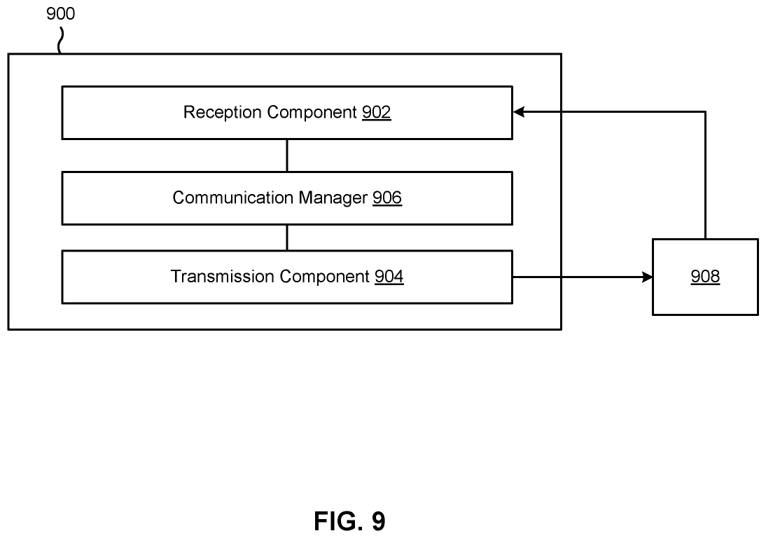

As shown in FIG. 7, in some aspects, process 700 may include receiving a reconfiguration message that includes a configuration error in configuration information (block 710). For example, the UE (e.g., using reception component 902 and/or communication manager 906, depicted in FIG. 9) may receive a reconfiguration message that includes a configuration error in configuration information, as described above.

As further shown in FIG. 7, in some aspects, process 700 may include transmitting a reconfiguration error message that indicates the configuration error (block 720). For example, the UE (e.g., using transmission component 904 and/or communication manager 906, depicted in FIG. 9) may transmit a reconfiguration error message that indicates the configuration error, as described above.

Process 700 may include additional aspects, such as any single aspect or any combination of aspects described below and/or in connection with one or more other processes described elsewhere herein.

In a first aspect, receiving the reconfiguration message includes receiving an RRC reconfiguration message that indicates the configuration information.

In a second aspect, transmitting the reconfiguration error message includes transmitting an RRC reconfiguration error message that indicates the configuration error.

In a third aspect, the reconfiguration error message includes a string that indicates the configuration error.

In a fourth aspect, a maximum allowed size of the string is specified by a communication standard.

In a fifth aspect, an allowed size of the string is undefined.

In a sixth aspect, process 700 includes selecting a string value from multiple preconfigured string values, and setting the string to the string value.

In a seventh aspect, transmitting the reconfiguration error message includes transmitting a bitfield, and each bit of the bitfield maps to a respective error category.

In an eighth aspect, the configuration error includes at least one of a violation of a communication standard, an incorrect band combination, a missing configuration parameter, an incorrect combination of settings, an incorrect value, a capability incompatibility, or an incorrect protocol layer parameter.

In a ninth aspect, the reconfiguration error message includes an information element that indicates the configuration error.

In a tenth aspect, process 700 includes transmitting an indication of an action performed based at least in part on the configuration error.

In an eleventh aspect, the action includes at least one of an RLF procedure, a cell barring procedure, or application of the configuration error.

In a twelfth aspect, transmitting the reconfiguration error message includes transmitting the reconfiguration error message using extended signaling.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with dynamic configuration failure messaging.

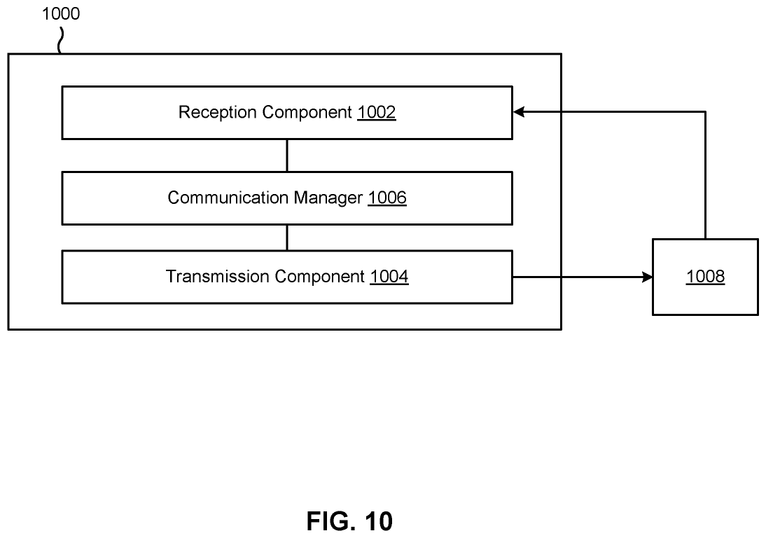

As shown in FIG. 8, in some aspects, process 800 may include transmitting a reconfiguration message that includes a configuration error in configuration information (block 810). For example, the network node (e.g., using transmission component 1004 and/or communication manager 1006, depicted in FIG. 10) may transmit a reconfiguration message that includes a configuration error in configuration information, as described above.

As further shown in FIG. 8, in some aspects, process 800 may include receiving a reconfiguration error message that indicates the configuration error (block 820). For example, the network node (e.g., using reception component 1002 and/or communication manager 1006, depicted in FIG. 10) may receive a reconfiguration error message that indicates the configuration error, as described above.

Process 800 may include additional aspects, such as any single aspect or any combination of aspects described below and/or in connection with one or more other processes described elsewhere herein.

In a first aspect, transmitting the reconfiguration message includes transmitting an RRC reconfiguration message that indicates the configuration information.

In a second aspect, receiving the reconfiguration error message includes receiving an RRC reconfiguration error message that indicates the configuration error.

In a third aspect, the reconfiguration error message includes a string that indicates the configuration error.

In a fourth aspect, a maximum allowed size of the string is specified by a communication standard.

In a fifth aspect, the string indicates a string value from multiple preconfigured string values.

In a sixth aspect, an allowed size of the string is undefined.

In a seventh aspect, receiving the reconfiguration error message includes receiving a bitfield, and each bit of the bitfield maps to a respective error category.

In an eighth aspect, the configuration error includes at least one of a violation of a communication standard, an incorrect band combination, a missing configuration parameter, an incorrect combination of settings, an incorrect value, a capability incompatibility, or an incorrect protocol layer parameter.

In a ninth aspect, the reconfiguration error message includes an information element that indicates the configuration error.

In a tenth aspect, process 800 includes receiving an indication of an action performed based at least in part on the configuration error.

In an eleventh aspect, the action includes at least one of an RLF procedure, a cell barring procedure, or application of the configuration error.

In a twelfth aspect, receiving the reconfiguration error message includes receiving the reconfiguration error message using extended signaling.

In a thirteenth aspect, process 800 includes decoding the configuration error using the reconfiguration error message.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive a reconfiguration message that includes a configuration error in configuration information. The transmission component 904 may transmit a reconfiguration error message that indicates the configuration error.

The communication manager 906 may select a string value from multiple preconfigured string values. Alternatively, or additionally, the communication manager 906 may set the string to the string value.

The transmission component 904 may transmit an indication of an action performed based at least in part on the configuration error.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit a reconfiguration message that includes a configuration error in configuration information. The reception component 1002 may receive a reconfiguration error message that indicates the configuration error. Alternatively, or additionally, the communication manager 1006 may decode the configuration error using the reconfiguration error message. In some aspects, the reception component 1002 may receive an indication of an action performed based at least in part on the configuration error.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving a reconfiguration message that includes a configuration error in configuration information; and transmitting a reconfiguration error message that indicates the configuration error.

Aspect 2: The method of Aspect 1, wherein receiving the reconfiguration message comprises: receiving a radio resource control (RRC) reconfiguration message that indicates the configuration information.

Aspect 3: The method of any of Aspects 1-2, wherein transmitting the reconfiguration error message comprises: transmitting a radio resource control (RRC) reconfiguration error message that indicates the configuration error.

Aspect 4: The method of any of Aspects 1-3, wherein the reconfiguration error message includes a string that indicates the configuration error.

Aspect 5: The method of Aspect 4, wherein a maximum allowed size of the string is specified by a communication standard.

Aspect 6: The method of Aspect 4, wherein an allowed size of the string is undefined.

Aspect 7: The method of any of Aspects 4-6, further comprising: selecting a string value from multiple preconfigured string values, and setting the string to the string value.

Aspect 8: The method of any of Aspects 1-7, wherein transmitting the reconfiguration error message comprises: transmitting a bitfield, wherein each bit of the bitfield maps to a respective error category.

Aspect 9: The method of any of Aspects 1-8, wherein the configuration error comprises at least one of: a violation of a communication standard, an incorrect band combination, a missing configuration parameter, an incorrect combination of settings, an incorrect value, a capability incompatibility, or an incorrect protocol layer parameter.

Aspect 10: The method of any of Aspects 1-9, wherein the reconfiguration error message comprises an information element that indicates the configuration error.

Aspect 11: The method of any of Aspects 1-10, further comprising: transmitting an indication of an action performed based at least in part on the configuration error.

Aspect 12: The method of Aspect 11, wherein the action comprises at least one of: a radio link failure (RLF) procedure, a cell barring procedure, or application of the configuration error.

Aspect 13: The method of any of Aspects 1-12, wherein transmitting the reconfiguration error message comprises: transmitting the reconfiguration error message using extended signaling.

Aspect 14: A method of wireless communication performed by a network node, comprising: transmitting a reconfiguration message that includes a configuration error in configuration information; and receiving a reconfiguration error message that indicates the configuration error.

Aspect 15: The method of Aspect 14, wherein transmitting the reconfiguration message comprises: transmitting a radio resource control (RRC) reconfiguration message that indicates configuration information.

Aspect 16: The method of any of Aspects 14-15, wherein receiving the reconfiguration error message comprises: receiving a radio resource control (RRC) reconfiguration error message that indicates the configuration error.

Aspect 17: The method of any of Aspects 14-16, wherein the reconfiguration error message includes a string that indicates the configuration error.

Aspect 18: The method of Aspect 17, wherein a maximum allowed size of the string is specified by a communication standard.

Aspect 19: The method of Aspect 17, wherein the string indicates a string value from multiple preconfigured string values.

Aspect 20: The method of Aspect 17, wherein an allowed size of the string is undefined.

Aspect 21: The method of any of Aspects 14-20, wherein receiving the reconfiguration error message comprises: receiving a bitfield, wherein each bit of the bitfield maps to a respective error category.

Aspect 22: The method of any of Aspects 14-21, wherein the configuration error comprises at least one of: a violation of a communication standard, an incorrect band combination, a missing configuration parameter, an incorrect combination of settings, an incorrect value, a capability incompatibility, or an incorrect protocol layer parameter.

Aspect 23: The method of any of Aspects 14-22, wherein the reconfiguration error message comprises an information element that indicates the configuration error.

Aspect 24: The method of any of Aspects 14-23, further comprising: receiving an indication of an action performed based at least in part on the configuration error.

Aspect 25: The method of Aspect 24, wherein the action comprises at least one of: a radio link failure (RLF) procedure, a cell barring procedure, or application of the configuration error.

Aspect 26: The method of any of Aspects 14-25, wherein receiving reconfiguration error message comprises: receiving the reconfiguration error message using extended signaling.

Aspect 27: The method of any of Aspects 14-26, further comprising: decoding the configuration error using the reconfiguration error message.

Aspect 28: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-13.

Aspect 29: An apparatus for wireless communication at a device, the apparatus comprising one or more memories and one or more processors coupled to the one or more memories, the one or more processors configured to cause the device to perform the method of one or more of Aspects 1-13.

Aspect 30: An apparatus for wireless communication, the apparatus comprising at least one means for performing the method of one or more of Aspects 1-13.

Aspect 31: A non-transitory computer-readable medium storing code for wireless communication, the code comprising instructions executable by one or more processors to perform the method of one or more of Aspects 1-13.

Aspect 32: A non-transitory computer-readable medium storing a set of instructions for wireless communication, the set of instructions comprising one or more instructions that, when executed by one or more processors of a device, cause the device to perform the method of one or more of Aspects 1-13.

Aspect 33: A device for wireless communication, the device comprising a processing system that includes one or more processors and one or more memories coupled with the one or more processors, the processing system configured to cause the device to perform the method of one or more of Aspects 1-13.

Aspect 34: An apparatus for wireless communication at a device, the apparatus comprising one or more memories and one or more processors coupled to the one or more memories, the one or more processors individually or collectively configured to cause the device to perform the method of one or more of Aspects 1-13.

Aspect 35: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 14-27.

Aspect 36: An apparatus for wireless communication at a device, the apparatus comprising one or more memories and one or more processors coupled to the one or more memories, the one or more processors configured to cause the device to perform the method of one or more of Aspects 14-27.

Aspect 37: An apparatus for wireless communication, the apparatus comprising at least one means for performing the method of one or more of Aspects 14-27.

Aspect 38: A non-transitory computer-readable medium storing code for wireless communication, the code comprising instructions executable by one or more processors to perform the method of one or more of Aspects 14-27.

Aspect 39: A non-transitory computer-readable medium storing a set of instructions for wireless communication, the set of instructions comprising one or more instructions that, when executed by one or more processors of a device, cause the device to perform the method of one or more of Aspects 14-27.

Aspect 40: A device for wireless communication, the device comprising a processing system that includes one or more processors and one or more memories coupled with the one or more processors, the processing system configured to cause the device to perform the method of one or more of Aspects 14-27.

Aspect 41: An apparatus for wireless communication at a device, the apparatus comprising one or more memories and one or more processors coupled to the one or more memories, the one or more processors individually or collectively configured to cause the device to perform the method of one or more of Aspects 14-27.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a +a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive a reconfiguration message that includes a configuration error in configuration information; and
transmit a reconfiguration error message that indicates the configuration error.

2. The apparatus of claim 1, wherein the one or more processors, to cause the UE to receive the reconfiguration message, are configured to cause the UE to:
receive a radio resource control (RRC) reconfiguration message that indicates the configuration information.

3. The apparatus of claim 1, wherein the one or more processors, to cause the UE to transmit the reconfiguration error message, are configured to cause the UE to:
transmit a radio resource control (RRC) reconfiguration error message that indicates the configuration error.

4. The apparatus of claim 1, wherein the reconfiguration error message includes a string that indicates the configuration error.

5. The apparatus of claim 1, wherein the configuration error comprises at least one of:
a violation of a communication standard,
an incorrect band combination,
a missing configuration parameter,
an incorrect combination of settings,
an incorrect value,
a capability incompatibility, or
an incorrect protocol layer parameter.

6. The apparatus of claim 1, wherein the one or more processors are further configured to cause the UE to:
transmit an indication of an action performed based at least in part on the configuration error.

7. The apparatus of claim 6, wherein the action comprises at least one of:
a radio link failure (RLF) procedure,
a cell barring procedure, or
application of the configuration error.

8. The apparatus of claim 1, wherein the one or more processors, to cause the UE to transmit reconfiguration error message, are configured to cause the UE to:
transmit the reconfiguration error message using extended signaling.

9. An apparatus for wireless communication at a network node, comprising:
one or more memories; and
one or more processors, coupled to the one or more memories, configured to cause the network node to:
transmit a reconfiguration message that includes a configuration error in configuration information; and
receive a reconfiguration error message that indicates the configuration error.

10. The apparatus of claim 9, wherein the one or more processors, to cause the network node to transmit the reconfiguration message, are configured to cause the network node to:
transmit a radio resource control (RRC) reconfiguration message that indicates the configuration information.

11. The apparatus of claim 9, wherein the one or more processors, to cause the network node to receive the reconfiguration error message, are configured to cause the network node to:
receive a radio resource control (RRC) reconfiguration error message that indicates the configuration error.

12. The apparatus of claim 9, wherein the reconfiguration error message includes a string that indicates the configuration error.

13. The apparatus of claim 9, wherein the configuration error comprises at least one of:
a violation of a communication standard,
an incorrect band combination,
a missing configuration parameter,
an incorrect combination of settings,
an incorrect value,
a capability incompatibility, or
an incorrect protocol layer parameter.

14. The apparatus of claim 9, wherein the one or more processors are further configured to cause the network node to:
receive an indication of an action performed based at least in part on the configuration error.

15. The apparatus of claim 9, wherein the one or more processors, to cause the network node to receive reconfiguration error message, are configured to cause the network node to:
receive the reconfiguration error message using extended signaling.

16. The apparatus of claim 9, wherein the one or more processors are further configured to cause the network node to:
decode the configuration error using the reconfiguration error message.

17. A method of wireless communication performed by a user equipment (UE), comprising:
receiving a reconfiguration message that includes a configuration error in configuration information; and
transmitting a reconfiguration error message that indicates the configuration error.

18. The method of claim 17, wherein the reconfiguration error message includes a string that indicates the configuration error.

19. The method of claim 17, wherein the configuration error comprises at least one of:
a violation of a communication standard,
an incorrect band combination,
a missing configuration parameter,
an incorrect combination of settings,
an incorrect value,
a capability incompatibility, or
an incorrect protocol layer parameter.

20. The method of claim 17, further comprising:
transmitting an indication of an action performed based at least in part on the configuration error.
